(19) United States
(12) Patent Application Publication
(10) Pub. No.: US 2005/0253737 A1
(43) Pub. Date: Nov. 17, 2005

(54) Method and system for confirmation of data

(75) Inventor: Michael Schweers, Meerbusch (DE)

Correspondence Address: THE FIRM OF KARL F ROSS, 5676 RIVERDALE AVENUE, PO BOX 900, RIVERDALE (BRONX), NY, 10471-0900, US

(73) Assignee: !SWEDMAT

(21) Appl. No.: 11/108,000

(22) Filed: Apr. 13, 2005

(30) Foreign Application Priority Data
Apr. 15, 2004 (EP) 04009005.2

(51) Int. Cl. B60Q 1/48

(52) U.S. Cl. 340/932.2; 701/1; 340/10.1; 340/5.8; 235/384; 705/13

(57) ABSTRACT

A data checking method in which an object which can be associated with an individual, especially a motor vehicle, can have a transponder with memory including data with respect to the individual and which can be read by a short-range radio forming part of a communication device of a monitoring purpose. A check can be made from a distance of a few meters between the monitoring person and the vehicle.

The invention relates to a method for checking data relating to a situation to be checked by a monitoring person relating to an object, in particular a vehicle, with the data to be checked containing both information relating to the object and relating to the situation to be checked and, in particular, being provided with manipulation protection, for example an electronic signature or the like.

The invention also relates to a system for checking data relating to a situation to be checked by a monitoring person relating to an object, in particular a vehicle, with the data to be checked containing both information relating to the object and relating to the situation to be checked and, in particular, being provided with manipulation protection, for example an electronic signature or the like. The invention also relates to a transponder and to a monitoring apparatus for a system such as this.

In this case, in general, there is no ownership relationship between the object with respect to which a specific situation must be checked and the monitoring person.

In practice, various methods are known in order to check data relating to a situation of an object by a monitoring person.

To this extent, for example when motor vehicles are being parked, a parking authorization can be checked by visually inspecting a parking ticket that is placed in the motor vehicle. Since the driver of the motor vehicle generally places the parking ticket on the dashboard on the driver's side and motor vehicles are normally parked on the right-hand side of the road, the monitoring person has to step into the road in order to check the parking ticket, and to this extent is at risk from the passing traffic. Another disadvantage is that, as a result of the direct examination of each motor vehicle, this is effectively regarded as “suspicious”, with an unpleasant effect on the driver of the vehicle being possible. Incidents between monitoring persons, such as traffic wardens, and vehicle drivers occur frequently and make the work of the monitoring persons harder.

The disadvantage of information located behind the windscreen is that it is difficult to identify, or else can no longer be identified at all from outside, when the glass is dirty and/or there is condensation on the windscreen.

It is also known that it is possible to only “register” a paid parking system by mobile radio, in which case parking permission is granted against appropriate payment, in which case it is then impossible to produce any written confirmation of the parking permission. One disadvantage in this case is that, in order to check the parking permission, the monitoring person has to contact the permission issuing centre, which is generally likewise done by mobile radio. The costs associated with it prevent economical use of this monitoring method, however.

In addition, passive “tags” are known, which are fitted to the motor vehicle and can be read by means of appropriate communication appliances. The passive tags are in this case supplied with energy by the reading process, so that it is possible to transmit the memory content. However, the range of such passive tags is very limited, at about 10 to 30 cm, so that they have the same disadvantages as printed parking tickets.

One object of the invention is to avoid the abovementioned disadvantages and to specify a capability by means of which data relating to a situation of an object can easily be checked by a monitoring person, and from a certain distance of a few meters.

This object is achieved by a method for checking data relating to a situation to be checked by a monitoring person relating to an object, in particular a vehicle, with the data to be checked containing both information relating to the object and relating to the situation to be checked and, in particular, being provided with manipulation protection, for example an electronic signature or the like, in which case the object is associated with an identification device, which in particular is in the form of a transponder and has a memory for storage of the data to be checked, which memory can be read by short-range radio by means of a communication device associated with the monitoring person, with the monitoring person using the communication device to pass on a request relating to the data to be checked to the identification device, and
either
in the case of corresponding data which is to be checked and is stored in the memory of the identification device, after reading and in particular checking this data for its validity, at least one signal is emitted on an indicating device, which is associated with the monitoring person, in order to confirm the requested situation,
or else
in the case of corresponding data which is to be checked and is not (yet) stored in the memory of the identification device, when, possibly only the information relating to the object, in other words to a motor vehicle and/or to a transponder tab has been, the monitoring person initiates a further request relating to the data to be checked, which further request is either made by long-range radio, by means of a further. communication device associated with him, to a central administration centre relating to the data to be checked, or via the communication device by short-range radio to a short-range radio interface, which is connected to the central administration centre, in the immediate vicinity, and, in the event of a confirmation from the central administration centre by long-range radio, the data to be checked is transmitted to the further communication device of the monitoring person, is indicated on the indicating device and is written to the memory of the identification device, by short-range radio, using the communication device. In this case, by way of example, the data may be accessed via a mobile Internet access or the like, which can either make use of mobile radio (long-range radio), or can use so-called hot spots (short-range radio).

This allows a monitoring person to check data relating to a situation of an object easily and from a certain distance of a few meters, so that there is no need to step on to the road and, furthermore, it is not immediately evident which motor vehicle is currently being checked by the monitoring person. To this extent, the costs for checking are kept low, since a data check by long-range radio, that is to say by mobile radio, is required only for the initial check of a specific situation, and a check on the basis of zero-cost short-range radio is sufficient for subsequent checks, for example by other monitoring persons, on the basis of the data transmitted to the identification device. The data may in this case be protected against manipulation, in particular in the form of a so-called electronic or digital signature; in this case, a checking device with appropriate checking and validity criteria is provided in the communication device of the monitoring person.

The communication device for checking the identification device by short-range radio and the indicating device can preferably, in particular, be integrated together with the further communication device for checking by long-range radio in a common monitoring apparatus, so that, on the one hand, only one appliance need be carried, and the costs for the hardware are kept low by means of a common housing and by avoiding a number of identical components. Since the monitoring process is primarily carried out by short-range radio, the mobile radio costs are also kept low since a request need be made to the central administration centre only for an “initial check” in each case, and, apart from this, the identification device can be read directly.

The object on which the invention is based is likewise achieved by a system for checking data relating to a situation to be checked by a monitoring person relating to an object, in particular a vehicle, with the data to be checked containing both information relating to the object and relating to the situation to be checked and, in particular, being provided with manipulation protection, for example an electronic signature or the like, in which case the object is associated with an identification device, which in particular is in the form of a transponder and has a memory for storage of the data to be checked, which memory can be read by short-range radio by means of a communication device associated with the monitoring person, in which case a request relating to the data to be checked can be passed by means of the communication device of the monitoring person to the identification device, and
either
in the case of corresponding data which is to be checked and is stored in the memory of the identification device, after reading and in particular checking this data for its validity, at least one signal can be emitted on an indicating device, which is associated with the monitoring person, in order to confirm the requested situation,
or else
in the case of corresponding data which is to be checked and is not (yet) stored in the memory of the identification device, when, possibly only the information relating to the object, in other words to a motor vehicle and/or to a transponder tab was received, a further request relating to the data to be checked, can be initiated by the monitoring person associated with the further communication device by long-range radio to a central administration centre relating to the data to be checked, or via the communication device by short-range radio to a short-range radio interface, which is connected to the central administration centre, in the immediate vicinity, and, in the event of a confirmation from the central administration centre by long-range radio, the data to be checked can be transmitted to the further communication device of the monitoring person, can be indicated on the indicating device and can be written to the memory of the identification device, by short-range radio, using the communication device.

This means that a check of the data relating to a situation of an object can be carried out by a monitoring person easily and from a certain distance of a few metres without having to step on to the road. It is also not immediately obvious which motor vehicle is currently being checked by the monitoring person, and the costs for the check are kept low, since a data check by long-range radio, that is to say by mobile radio, is required only for the initial check of a specific situation while, in contrast, a check by zero-cost short-range radio is sufficient for subsequent checks, for example by other monitoring persons, on the basis of the data transmitted to the identification device.

The data may in this case be protected against manipulation, in particular in the form of a so-called electronic or digital signature; in this case, a checking device with appropriate checking and validity criteria is provided in the communication device of the monitoring person.

The communication device for checking the identification device by short-range radio and the indicating device can preferably, in particular, be integrated together with the further communication device for checking by long-range radio in a common monitoring apparatus.

A transponder for a system of the type mentioned above is also used to achieve the object according to the invention, with the transponder on the one hand having a unique identification tag and the memory being in the form of a read/write memory, in particular without an erase function.

In this case, the transponder can be provided with an on/off switching function which, in particular, allows pulsed standby operation (polling), thus ensuring that the transponder has as long an operating life as possible, without replacement or recharging of the energy source, by saving further energy. In this case, in the standby mode, the transponder may also just be ready to receive requests, being completely activated again only on detection or reception of a request.

The transmission frequency of the transponder can also be optimized with respect to the current drawn and the range for operation in a vehicle and reliable reading by a monitoring person, thus resulting in a range which is just sufficient, so that the power consumption is kept as low as possible.

The object according to the invention is also achieved by a monitoring apparatus for a system of the type mentioned above, with range matching being provided. This reduces the number of identification devices which “respond” to a request from the monitoring person, so that the monitoring person can find out the correct requested data from the various received data records quickly and without any long selection process, and can check them further.

According to the invention, an indication can be provided for the position of the identification device which is currently being checked, so that, if a number of data records are received in response to a request, it is possible to select the data record to be checked solely on the basis of “geographical” criteria.

The object according to the invention is also achieved by a central administration centre for a system of the type mentioned above, in which case a memory is provided for data relating to a situation (to be checked by a monitoring person) of an object, in particular of a vehicle, and a communication device is provided for communication by short-range radio and/or by long-range radio. This allows a central administration centre such as this to be used either for a very large area, such as an entire city region or the like, with long-range radio then being used, although, either additionally or exclusively, locally highly restricted use is also possible, for example only a small number of motor vehicle parking areas, meaning that only short-range radio is necessary.

In this case, at least one communication device (which is in the form in particular of a responder and is connected to the memory for the central administration centre) of the central administration centre can be integrated in a road or building furniture item, such as an automatic parking ticket machine a bollard or barrier system, so that a central billing unit can be checked by short-range radio at a car park or the like. This is worthwhile, by way of example, in so-called real time billing methods, in which a parking ticket can be issued for a long time period and can be stored in the motor vehicle, and, provided that the parking time that has been paid for is not required part of the amount can be refunded. The monitoring person who in a situation such as this finds a supposedly valid parking ticket in the motor vehicle must then check whether the payment made for this parking ticket has possibly already been partially refunded and, in consequence, the vehicle is currently using the car park without having paid a usage fee.

Such transponders or else responders may, if required, even act as a relay station and may pass on a request by short-range radio to a central administration centre.

The object according to the invention is also achieved by a method for checking data relating to a situation to be checked by a monitoring person relating to an object, in particular a vehicle, with the data to be checked containing both information relating to the object and relating to the situation to be checked and, in particular, being provided with manipulation protection, for example an electronic signature or the like, in which case the object is associated with an identification device, which in particular is in the form of a transponder and has a memory for storage of the data to be checked, which memory can be read by short-range radio by means of a communication device associated with the monitoring person, with the monitoring person using the communication device to pass on a request relating to the data to be checked to the identification device, and in the case of corresponding data which is to be checked and is stored in the memory of the identification device, after reading and in particular checking this data for its validity, at least one signal is emitted on an indicating device, which is associated with the monitoring person, in order to confirm the requested situation. A method such as this may, for example, be used to read and check a tachograph in a motor vehicle and, in this case, in particular, the tachograph may be read while driving and even without this being noticed by the vehicle driver.

1. A method for checking data relating to a situation to be checked by a monitoring person relating to an object, in particular a vehicle, with the data to be checked containing both information relating to the object and relating to the situation to be checked and, in particular, being provided with manipulation protection, for example an electronic signature or the like, wherein the object is associated with an identification device, which in particular is in the form of a transponder and the identification device has a memory for storage of the data to be checked, which memory can be read by short-range radio by means of a communication device associated with the monitoring person, with the monitoring person using the communication device to pass on a request relating to the data to be checked to the identification device, and
either
in the case of corresponding data which is to be checked and is stored in the memory of the identification device, after reading and in particular checking this data for its validity, at least one signal is emitted on an indicating device, which is associated with the monitoring person, in order to confirm the requested situation,
or else
in the case of corresponding data which is to be checked and is not (yet) stored in the memory of the identification device, the monitoring person initiates a further request relating to the data to be checked, which further request is either made by long-range radio, by means of a further communication device associated with him, to a central administration centre relating to the data to be checked, or via the communication device by short-range radio to a short-range radio interface, which is connected to the central administration centre, in the immediate vicinity, and, in the event of a confirmation from the central administration centre by long-range radio, the data to be checked is transmitted to the further communication device of the monitoring person, is indicated on the indicating device and is written to the memory of the identification device, by short-range radio, using the communication device.

2. The method according to claim 1 wherein the communication device for checking the identification device by short-range radio and the indicating device are integrated in a common monitoring apparatus, in particular together with the further communication device for checking by long-range radio.

3. A system for checking data relating to a situation to be checked by a monitoring person relating to an object, in particular a vehicle, with the data to be checked containing both information relating to the object and relating to the situation to be checked and, in particular, being provided with manipulation protection, for example an electronic signature or the like, wherein the object is associated with an identification device, which in particular is in the form of a transponder and has a memory for storage of the data to be checked, which memory can be read by short-range radio by means of a communication device associated with the monitoring person, in which case a request relating to the data to be checked can be passed on by means of the communication device of the monitoring person to the identification device, and
either
in the case of corresponding data which is to be checked and is stored in the memory of the identification device, after reading and in particular checking this data for its validity, at least one signal can be emitted on an indicating device, which is associated with the monitoring person, in order to confirm the requested situation, or else
in the case of corresponding data which is to be checked and is not (yet) stored in the memory of the identification device, a further request relating to the data to be checked can be initiated by the monitoring person associated with the further communication device by long-range radio to a central administration centre relating to the data to be checked, or via the communication device by short-range radio to a short-range radio interface, which is connected to the central administration centre, in the immediate vicinity, and, in the event of a confirmation from the central administration centre by long-range radio, the data to be checked can be transmitted to the further communication device of the monitoring person, can be indicated on the indicating device and can be written to the memory of the identification device, by short-range radio, using the communication device.

4. The system according to claim 1 wherein the communication device for checking the identification device by short-range radio and the indicating device are integrated in a common monitoring apparatus, in particular together with the further communication device for checking by long-range radio.

5. A transponder for a system according to claim 3 wherein the transponder on the one hand has a unique identification tag and the memory is in the form of a read/write memory, in particular without an erase function.

6. A transponder according to claim 5 wherein the transponder is provided with an on/off switching function which, in particular, allows pulsed standby operation.

7. A transponder according to claim 5 wherein the transmission frequency of the transponder is optimized in terms of the current drawn and the range for operation in a vehicle and for reading by a monitoring person.

8. A monitoring apparatus for a system according to claim 4 wherein range matching is provided.

9. The monitoring apparatus according to claim 8 wherein an indication is provided for the position of the identification device which is currently being checked.

10. A central administration centre for a system according to claim 3 wherein a memory is provided for data relating to a situation (which is to be checked by a monitoring person) of an object, in particular of a vehicle, and a communication device is provided for communication by short-range radio and/or by long-range radio.

11. administration centre according to claim 10 wherein at least one communication device (which, in particular, is in the form of a responder and is connected to the memory of the central administration centre) for the central administration centre is integrated in a road or building furniture item, such as an automatic parking ticket machine, a bollard or a barrier system.

12. A method for checking data relating to a situation to be checked by a monitoring person relating to an object, in particular a vehicle, with the data to be checked containing both information relating to the object and relating to the situation to be checked and, in particular, being provided with manipulation protection, for example an electronic signature or the like, wherein the object is associated with an identification device, which in particular is in the form of a transponder and has a memory for storage of the data to be checked, which memory can be read by short-range radio by means of a communication device associated with the monitoring person, with the monitoring person using the communication device to pass on a request relating to the data to be checked to the identification device, and in the case of corresponding data which is to be checked and is stored in the memory of the identification device, after reading and in particular checking this data for its validity, at least one signal is emitted on an indicating device, which is associated with the monitoring person, in order to confirm the requested situation.
